(19) United States
(12) Patent Application Publication
(10) Pub. No.: US 2007/0178031 A1
(43) Pub. Date: Aug. 2, 2007

(54) Process for upgrading an ore or concentrate

(75) Inventors: Paul Christopher Freeman, Woodvale (AU); Sally Elizabeth Bryant, Roxby Downs (AU); Oliver Michael Griffiths Newman, Woodville (AU)

Correspondence Address: MERCHANT & GOULD PC, P.O. BOX 2903, MINNEAPOLIS, MN, 55402-0903, US

(73) Assignee: ZINIFEX LIMITED, Melbourne (AU)

(21) Appl. No.: 10/566,032

(22) PCT Filed: Jul. 12, 2004
(86) PCT No.: PCT/AU04/00939

§ 371 Date: Apr. 2, 2007

(30) Foreign Application Priority Data
Jul. 18, 2003 (AU) 2003903741

(51) Int. Cl. C01G 9/00; B01J 8/00

(52) U.S. Cl. 423/109; 422/189

(57) ABSTRACT

According to the present invention there is provided a process for upgrading an ore or concentrate that contains metal sulphur minerals and gangue material. The process includes the stages of: a) selectively leaching the ore or concentrate using an ammoniacal solution containing ammonium carbonate that forms soluble metal ammine complexes; b) separating the solid and liquid phases formed in stage a) with the liquid phase forming a solution including soluble metal ammine complexes and the solid phase including at least in part the gangue material; c) removing ammonia and carbon dioxide from the liquid phase formed in step b) under conditions so as to selectively precipitate the valuable metal(s); and d) separating the solid and liquid phases formed in stage c) with the solid phase forming a more-concentrated source of valuable metal.

### FIELD OF THE INVENTION

The present invention relates to a hydrometallurgical process for upgrading a mineral ore or concentrate to a chemical intermediate as a more-concentrated source of metal. In particular, the present invention relates to a process for upgrading a mineral ore, such as although not exclusively, to zinc sulphide minerals.

### BACKGROUND OF THE INVENTION

The present invention was made to further improve the recovery of zinc in the processing of an ore body at Century in Northern Queensland. Most of the zinc is recovered as a zinc concentrate containing zinc sulphide. Typically the zinc sulphide is in the mineral form of sphalerite

The dominant process for the production of zinc metal from zinc sulphide concentrates is the Roast-Leach-Electrowinning (RLE) process. This process is conducted in large efficient smelters that are capable of producing zinc metal of high purity.

The electrowinning stage is energy-intensive and, as a consequence, RLE plants are located in regions that offer low cost electrical power which is typically some distance from a remote mine site. The transport costs for transferring concentrates and other materials to the RLE plants, roasting performance considerations and the need to minimise the quantities of residues generated at the RLE site all encourage the use of high-grade zinc concentrates, which are correspondingly low in impurities such as iron and silica.

High-grade concentrates can be produced in most zinc mines by compromising metal recovery, both at the mining and concentrating stages. In some cases, despite the rich nature of the deposits, the mineral structure of the ores is such that suitable concentrate grades cannot, economically, be produced.

Responses to this situation have seen the development of processes, such as the Imperial Smelting Process, which are capable of processing medium/low grade concentrates (in the form of mixed lead-zinc concentrates) to metals of moderate purity. Although a relatively high-cost route (requiring a sinter plant, furnace, a lead refinery and a zinc refinery), it has been a successful alternative and currently represents about 10% of world smelting capacity. However, due to low metal prices, a number of these smelters have recently been closed.

Processes to directly leach metal sulphide ores or concentrates have been studied extensively. An oxidative acid ferric leach, for example, conveniently yields a zinc sulphate solution, from which (after solution purification) zinc can be electro-won. Acid leaching of concentrates, in pressure vessels, is practiced at two plants in Canada and ambient-pressure acid leaching has been introduced at another plant in Finland.

There are few mine-site hydrometallurgical plants, indicating the common difficulty in obtaining low-cost power in remote locations and the understandable reluctance to invest the capital for a smelter unless a long mine life is assured.

An alternative approach is to use a mine-site hydrometallurgical process to produce a zinc chemical intermediate, with just the electrowinning stage to be conducted at the second location. From a zinc sulphate solution, for example, a precipitate of zinc sulphate (ZnSO₄) or basic zinc sulphate (3Zn(OH)₂.ZnSO₄) can readily be produced. Transfer of sulphate to the electrolytic plant may, however, create a sulphate disposal problem at the smelter.

It is an object of the present invention to provide an alternative process for separating the valuable metal and sulphur constituents of an ore or concentrate to provide the more-concentrated source of valuable metal in a non-sulphate form.

### SUMMARY OF THE INVENTION

The present invention is based on the realisation that metal sulphur compounds can be dissolved away from their host mineral ore or concentrate by using an ammoniacal solution containing ammonium carbonate (AAC solution) and then selectively precipitated to make a more-concentrated source of metal which is, relatively, sulphur-free.

In a situation in which the mineral ore or concentrate contains a valuable metal such as zinc in the form of sphalerite, the present invention enables the zinc and sulphur constituents to be separated so that the zinc constituent can form a product that is attractive to electrolytic plants.

According to the present invention there is provided a process for upgrading an ore or concentrate that contains metal sulphur minerals and gangue material. The process includes the stages of:

a) selectively leaching the ore or concentrate using an ammoniacal solution containing ammonium carbonate that forms soluble metal ammine complexes;

b) separating the solid and liquid phases formed in stage a) with the liquid phase forming a solution including soluble metal ammine complexes and the solid phase including at least in part the gangue material;

c) removing ammonia and carbon dioxide from the liquid phase formed in step b) under conditions so as to selectively precipitate the valuable metal(s); and

d) separating the solid and liquid phases formed in stage c) with the solid phase forming a more-concentrated source of valuable metal.

It will be appreciated by a person skilled in the art of the present invention that stages a) to d), or any of the other stages described above may be carried out consecutively or disjunctively and may, for example, be carried out at different plant sites.

Depending on the operating conditions under which stages a) and c) are carried out, the solids formed may preferentially comprise metal oxides, hydroxides and carbonates.

An advantage provided by the present invention is that valuable metals precipitated in stage c), such as zinc, silver and copper can form a metal salt with an anion other than with a sulphur containing anion such as a sulphate.

Another advantage is that very few of the major constituents of the gangue material (notably iron and silica) are soluble in an AAC solution and, therefore, will form a major portion of the solid phase formed at stage b).

It is preferred that the AAC solution used in stage a) have a pH ranging from 7 to 10.5.

It is preferred that stage a) be carried out at a temperature ranging from 60 to 99° C. when at atmospheric pressure. It is possible that stage a) may be carried out at higher temperatures and pressures.

It is preferred that the method includes adding to stage a) a metal oxidant that undergoes a reduction reaction to facilitate the dissolution of the metal sulphur compounds.

It is preferred that the metal oxidant be in the form of a cupric cation (ie Cu²⁺). This copper may be all sourced from the ore itself during the leach reaction, or may be supplemented by being added in the form of a copper chemical.

In a situation in which the valuable metal is zinc and the material being upgraded is, for example in the form of sphalerite (ZnS), the dissolution of sphalerite may be represented by the following reaction:
ZnS+8Cu(NH₃)₄CO₃+4H₂O→Zn(NH₃)₄CO₃+4Cu₂(NH₃)₄CO₃+(NH₄)₂SO₄+3(NH₄)₂CO₃+4NH₃ Reaction A

An advantage in using a divalent copper cation as the metal oxidant is that it can be regenerated using oxygen by the following oxidation reaction:
2Cu₂(NH₃)₄CO₃+O₂+4NH₃+2(NH₄)₂CO₃→4Cu(NH₃)₄CO₃+2H₂O Reaction B

Although it is possible that Reaction B occur in a separate stage, it is preferred that an oxygen containing gas be supplied to stage a) such that Reactions A and B can occur simultaneously. Indeed, a difficulty that may be encountered if oxygen is not supplied to stage a) is that the copper in solution may precipitate as a copper sulphide.

Although air may be used as the oxygen containing gas, it is preferred that a purified oxygen source be used as it provides a faster reaction rate and reduces heat losses to the associated nitrogen gas.

In addition, in order to facilitate continuous operation, an amount of make-up copper will need to be added to stage a).

When oxygen is supplied simultaneously, the overall reaction occurring at stage a) may be represented by the following reaction:
ZnS+2O₂+4NH₃+(NH₄)₂CO₃→Zn(NH₃)₄CO₃+(NH₄)₂SO₄ Reaction C

It is preferred that the concentration of copper cations in the ammoniacal solution used in stage a) be at least 0.15 g/L so that the copper concentration does not limit the reaction rate.

It is preferred that the ammoniacal solution in stage a) contains ammonia at a concentration that is sufficient to stably maintain the metal ions, that form ammine complexes, in solution. In order to do this it is envisaged that an excess of ammonia over the stoichiometric minimum will be required. As a guide, the minimum total ammonia level (for the case of zinc with copper) can be calculated by the following formulae:
[NH₃]≧([Zn]+[Cu])×8)+([SO₄]×2) Formulae A
where the concentrations are in mol/L.

As an example, in a situation in which the concentration of zinc in stage a) is 30 g/L, the concentration of ammonia (total) in the solution in stage a) should be approximately no less than 80 g/L.

It is also desirable that an excess over stoichiometric of dissolved carbon dioxide (or carbonate/bicarbonate) also be supplied.

It is preferred that stage c) be carried out under conditions to minimise the precipitation of sulphur and sulphur containing compounds. More particularly, it is preferred that stage c) be carried out at a temperature ranging from 90° C. to boiling point so as to reduce the equilibrium levels of dissolved ammonia and carbon dioxide and thereby destabilise metal amine compounds. It is preferred that steam be sparged through the liquid phase of stage c) as this not only provides an efficient source of heat but also provides a carrier gas for further ammonia removal.

As ammonia is removed, the metals begin to precipitate as a mixture of hydroxide-carbonate compounds substantially free of sulphur and in particular sulphate compounds. This was surprising to us, as the level of sulphide in solution is about 50% higher than for zinc—in terms of mass per litre. As the reaction proceeds and the concentrations of dissolved ammonia and carbon dioxide fall (a trend readily followed by monitoring the pH), the metals tend increasingly to precipitate as the basic metal sulphate. This is undesirable as it effectively down-grades the attractiveness of the precipitate to the smelter. It is preferred that stage c) be carried out to an end pH of 6.8 or more to avoid excessive amounts of metal sulphate forming. Those skilled in the art will appreciate that other operating parameters such as temperature and residence time will also influence the properties of the precipitate.

In a situation in which the valuable metal is zinc, the precipitation of zinc and the evaporation of ammonia occurring in stage c) can be represented by a reaction such as:
11Zn(NH₃)₄CO₃+48H₂O→8Zn(OH)₂.3ZnCO₃.4H₂O↓+8(NH4)₂CO₃+28NH₄OH Reaction D

Although Reaction D shows a zinc hydroxide-carbonate precipitate, zinc may also be precipitated in other forms including the basic carbonate and basic zinc sulphate.

Ammonium carbonate and ammonium hydroxide is also unstable in conditions under which stage c) is preferably carried out and may break down according to the following reactions.
(NH₄)₂CO₃→H₂O+CO₂↑+2NH₃↑ Reaction E
NH₄OH→H₂O+NH₃↑ Reaction F

In order to further increase the proportion of valuable metal in the solid phase formed in stage c), it is preferred that the process includes a stage of calcining the solid phase recovered in stage d). The calcination stage involves at least part of the metal carbonates and possibly hydroxides being converted to a metal oxide.

It is preferred that the calcining stage be carried out by heating the solid phase formed in stage c) to a temperature of 100° C. or more to drive off water and 300° C. or more to decompose the carbonate.

The liquid phase from stage d contains significant quantities of ammonium sulphate which can be crystallised using standard equipment to form a by-product that can be used by agricultural fertiliser manufacturers.

It is preferred that the liquid phase from stage d) be treated to precipitate sulphur and compounds containing sulphur from the liquid phase as a salt. An advantage provided by this preferred aspect of the invention is that additional ammonia can be recovered for reuse.

It is preferred that the liquid phase from stage d) be treated by adding a neutralising agent to the liquid phase. An example of a suitable neutralising agent is lime (CaO) and the sulphur-containing salt produced is calcium sulphate (ie gypsum).

It is preferred that the neutralising agent maintain the pH above 7 during the sulphate precipitation stage to minimise the level of ammonia remaining as ammonium hydroxide.

It is preferred that ammonia be removed from the liquid phase in stage d) by heating the liquid phase and sparging with steam. This can take place simultaneously with, or subsequent to, the treatment with lime.

The sulphate precipitation stage may be represented by the following reaction:
(NH₄)₂SO₄+Ca(OH)₂→2NH₃↑+CaSO₄↓(gypsum)+2H₂O Reaction G

It is preferred that the ammonia volatilised/vapourized from either stage c) and/or the stage for precipitating the sulphate ions be recovered and reused in stage a). Standard equipment and process know-how—involving packed towers for ammonia and carbon dioxide recovery from vapours and distillation columns for production of a concentrated ammonia/ammonium carbonate liquid for recycling—are available, for this.

The present invention also encompasses a solid phase made substantially of a metal oxide and any of the other solid and liquid phases including the gypsum formed in sulphate precipitation stage made according to the process of the present invention.

The present invention also encompasses a plant including at least two reactor vessels for carrying out stages a) and c) and at least two solid/liquid separation devices for carrying out stages b) and d) of the process.

### DETAILED DESCRIPTION OF THE INVENTION

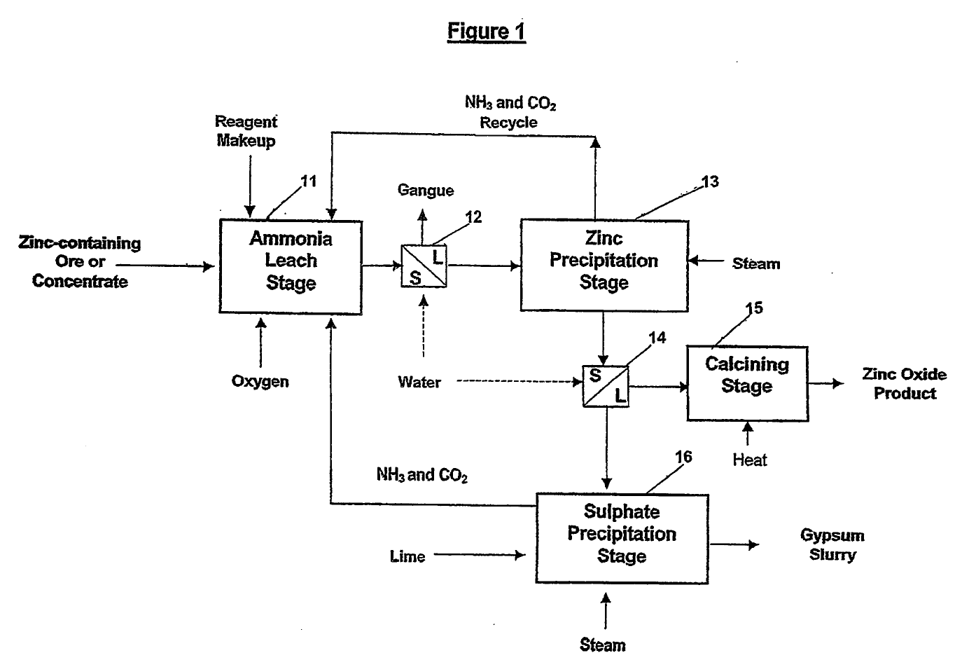

A detailed description of a preferred embodiment of the present invention will now be described with reference to FIG. 1.

The description is in the context of a zinc refining plant. However, the present invention is not confined to treating this valuable metal and is equally applicable to other valuable metals, such as copper.

In terms of process flow, the preferred embodiment includes an ammonia leaching stage 11 that is supplied with a zinc containing feed material such as an ore or concentrate, an AAC solution and oxygen. The AAC solution and feed material form a slurry in the leaching stage 11. Once reacted in the leaching stage 11, the slurry is fed to a solid/liquid separator 12 in which the liquid phase is separated from the solid phase which is largely constituted by insoluble gangue material. The liquid phase is then supplied to a zinc precipitation stage 13 in which a zinc containing solid phase is precipitated and thereby forms a slurry. The slurry is then fed to another solid/liquid separator 14 in which the liquid phase is separated from the solid phase. The solid zinc containing phase is then fed to a optional calcining stage 15 to yield a product that is, substantially, zinc oxide. The liquid phase formed in separator 14 is further treated in an optional sulphate precipitation stage 16 to further recover ammonia and precipitate gypsum—which is a valuable byproduct in some circumstances.

Ammonia and carbon dioxide are evaporated in the zinc and sulphate precipitation stages 13 and 16, and are recycled back to the ammonia leaching stage 11.

The operational characteristics of each stage will now be described in more detail.

The ore or concentrate fed to the ammonia leaching stage 11 comprises sphalerite (ZnS) and gangue material including iron and silicate minerals.

An ammoniacal/ammonium stream is fed to the ammonia leach stage.

If the amount of soluble copper in the ore is insufficient, a source of copper ions is also added to the reactor. This can conveniently be in the form of a solution of copper sulphate in water. Copper (both Cu¹⁺ and Cu²⁺) will form copper ammine ions in the AAC.

According to Reaction A, the cupric cations function as an oxidising agent such that the zinc constituent of the feed material also forms a soluble ammine complex. There are several advantages in using copper as an oxidising agent. Firstly, it forms soluble ammine complexes in a pH range of 7.0 to 10.5 and at a temperature ranging from 60 to 95° C., whereas the gangue in the feed material is substantially insoluble at these conditions. Secondly, the copper oxidising agent can be conveniently regenerated using oxygen according to Reaction B set out above.

The overall oxidation/reduction that dissolves sphalerite in leaching stage 11 is represented by Reaction C, set out above.

In some instances sphalerite may be directly oxidised by oxygen according to the following reaction:
ZnS+4NH₃+2O₂→Zn(NH₃)₄SO₄ Reaction H

However, it will be appreciated that the “products” formed by Reactions C and H will exist in solution as disassociated ions and ammonia carbonate will exist in solution as a mixture of bicarbonate, carbonate and free ammonia.

In the instance when the raw material includes zinc carbonate, it can be dissolved according to the following reaction:
ZnCO₃+4NH₃→Zn(NH₃)₄CO₃ Reaction I

Ammonia is distributed in solution between the copper and zinc ammine complexes, ammonium bicarbonate, ammonium sulphate and as hydrolysed ammonia. The amount of ammonia in solution will affect the amount of zinc and copper ions that can be maintained in solution. As a guideline, the minimum ammonia level required can be estimated by the following formulae in which the concentrations of zinc, copper and sulphate are the concentrations (mol/L) present in stage 11.
[NH₃]ₘᵢₙ=([Zn]+[Cu])×8)+([SO₄]×2)

When the concentration of zinc present in stage a) is 30 g/L, the minimum recommended concentration of NH₃ in the AAC solution is 80 g/L.

The rate at which zinc is leached in stage 11 is temperature dependent. A temperature of between 60 and 95° C. has been adequate for trials conducted to date. It may be beneficial to conduct the leaching stage 11 at higher temperatures and pressures to achieve a higher reaction rate.

The leaching stage 11 is also dependent on sufficient oxygen being available to regenerate Cu²⁺ ions. In principle air could be used, but purified oxygen is preferred as it gives faster reaction rates and the heat losses will be lower.

If the dissolved oxygen level is not maintained during the course of the leach reaction, copper is likely to be precipitated, removing it from an active role according to the following reaction:
2Cu₂(NH₃)₄CO₃+ZnS→Zn(NH₃)₄CO₃+Cu₂S↓ Reaction J

Any gases formed, or introduced with the oxygen, will need to be vented from the ammonia leach stage 11. As ammonia and carbon dioxide are quite volatile, there will be an ammonia loss with these gases, requiring offgas treatment using condensers or water scrubbers (not illustrated in FIG. 1).

Once the zinc has been dissolved, and un-reacted material removed in the solid/liquid separator 12, the objective is to recover the zinc.

The zinc ammine complex can be broken by heating the solution to (near) boiling and sparging with steam. This drives off ammonia and carbon dioxide and precipitates zinc as the hydroxide-carbonate according to Reaction D set out above. Zinc carbonates may also be present in the solid phase.

As can be seen from FIG. 1, the ammonia and carbon dioxide are recyclable back to the leaching stage 11. Makeup AAC solution may also be fed to the leach stage 11 if needed.

As the ammonia is removed, the zinc will precipitate, ideally as an hydroxide-carbonate according to Reaction D. The zinc may also precipite as a basic zinc carbonate according to the following reaction:
5Zn(NH₃)₄CO₃+3H₂O→3(ZnO.H₂O).2ZnCO₃↓+20NH₃↑+3CO₂↑ Reaction K

While reaction K does not contaminate the zinc product with sulphate ions, it does reduce the overall grade of the precipitate because the zinc content of the solids in the hydroxide form is about 66%, whereas the basic zinc carbonate only contains about 60% zinc. As the pH drops with the removal of ammonia and carbon dioxide, there is a greater tendency for zinc to precipitate as a basic sulphate according to the following reaction:
4Zn(NH₃)₄CO₃+(NH₄)₂SO₄+2H₂O→3Zn(OH)₂.ZnSO₄↓+4CO₂↑+18NH₃↑ Reaction L

The selected end point for the precipitation reaction in stage 13 is a trade-off between maximising the zinc precipitation and minimizing sulphate contamination of the precipitate. Alternatively, zinc can be further encouraged to precipitate in the hydroxide form by addition of an alkali (e.g. caustic soda) that maintains the pH at a suitable, higher value.

The slurry formed in the zinc precipitation stage 13 is then fed to a solid/liquid separator 14 and the solid phase containing the zinc constituents is fed to the calcining stage 15.

The calcining stage 15 essentially converts the zinc hydroxide-carbonates to zinc oxide. This will reduce the mass to be transported to the electrowinning refinery and minimise contamination of the product with ammonia. The calcining stage 15 is carried out by heating the precipitate to above 300 ° C.

The liquid phase from stage 14 contains significant quantities of ammonium sulphate which can be crystallised using standard equipment to form a by-product that can be used by agricultural fertiliser manufacturers.

Alternatively the ammonia can be recovered. This is achieved by reacting the liquid phase in stage 16 with a reagent such as lime or limestone to form gypsum, which precipitates. Boiling and/or steam sparging the liquid is used simultaneously with, or subsequent to, the treatment with lime to volatilise the dissolved ammonia.

If not valued as a byproduct, the resulting gypsum slurry in stage 16 may conveniently be fed directly to a tailings dam at a mine site.

The ammonia and carbon dioxide evaporated in stages 13 and 16 can be recovered and reused in stage 11. Standard equipment and process know-how—involving packed towers for ammonia and carbon dioxide recovery from vapours and distillation columns for production of a concentrated ammonia/ammonium carbonate liquid for recycling—are available, for this.

Set out below is a description of a trial carried out according to the preferred embodiment of the present invention.

### EXAMPLE 1

### Ammonia Leach

An AAC leaching stage was conducted in a 3 L reactor at 85° C. for 5 hours, with oxygen sparging at 600 ml/min. The starting material was 200 g of a low-grade concentrate containing 15% Zn, in the form of sphalerite, slurried with water to a pulp density of 200 g dry solids/litre solution. After heating to 85° C., 400 g of ammonium hydrogen carbonate was then added together with 250 ml of a 25 wt % ammonia solution. Cupric ions were added in the form of copper sulphate (3 g in 30 ml of water) and the reaction commenced. The pH was controlled during the test at 8.7 by automatic additions of the ammonia solution. At the conclusion of the test the slurry was filtered, washed and analysed. The filtrate is feed for the zinc precipitation stage and the solid is waste gangue material.

Results of the analysis of the filtrate provided an assay as set out below.

The zinc extraction was 91.4% after 5 hours. Zinc in the form of zinc silicate was not extracted from the solid phase. There was extraction of other elements (i.e. lead, manganese) but they are not stable in solution and precipitated (probably as carbonates) and are disposed of in the gangue. Cadmium and copper (in the feed material) are extracted and are stable in solution.

TABLE 1
Ammonia leach assays

| Time | | | | | | | |
|---|---|---|---|---|---|---|---|
| (hrs) | | | | | | | |
| Solutions (g/L) | Zn | Cu | SiO2 | Ca | NH3 | SO4 | Tot S |
| 0 | 0 | 0.28 | 0.003 | 0.009 | 50.3 | 4.5 | 1.8 |
| 0.5 | 8.1 | 0.13 | 0.002 | 0.012 | 47.6 | 6.2 | 5.1 |
| 1 | 11.8 | 0.37 | 0.001 | 0.006 | 35.5 | 13.3 | 6.5 |
| 2 | 15.9 | 0.46 | 0.002 | 0.007 | 29.1 | 23.5 | 8.3 |
| 3 | 14.8 | 0.44 | 0.001 | 0.006 | 34.3 | 23.0 | 7.7 |
| 4 | 14.7 | 0.43 | 0.001 | 0.008 | 28.3 | 23.8 | 8.0 |
| 5 | 14.3 | 0.41 | 0.001 | 0.005 | 31.9 | 22.6 | 7.6 |

| Solids (%) | Zn | Cu | Pb | SiO2 | Ca | SO4 | Tot S |
|---|---|---|---|---|---|---|---|
| 0 | 15.1 | 0.10 | 0.53 | 48.4 | 0.49 | 0.4 | 9.3 |
| 0.5 | 9.7 | 0.30 | 0.43 | 51.1 | 0.57 | <0.1 | 7.2 |
| 1 | 6.6 | 0.13 | 0.45 | 55.5 | 0.66 | 0.3 | 5.5 |
| 2 | 2.5 | 0.03 | 0.56 | 57.3 | 0.68 | 0.2 | 3.2 |
| 3 | 2.0 | 0.03 | 0.56 | 56.3 | 0.64 | <0.1 | 2.8 |
| 4 | 1.7 | 0.03 | 0.55 | 56.8 | 0.62 | <0.1 | 2.5 |
| 5 | 1.4 | 0.02 | 0.57 | 56.0 | 0.64 | <0.1 | 2.3 |

The solid residue containing gangue material was wash tested. The concentration of ammonia before washing was approximately 0.1% and <0.1% after three washes. This demonstrates that ammonia can be effectively recovered by washing the residue.

### EXAMPLE 2

### Zinc Precipitation

The solution from the ammonia leach stage was heated to about 95° C. and sparged with oxygen (experimentally, a convenient carrier gas) at 400 ml/min for 3.5 hours. Over this time, a precipitate formed and the pH dropped from 8.8 to 6.8. In a series of experiments, the reaction was halted at different final pH levels and the resulting precipitates were filtered and analysed. The analysis provided the following assays.

TABLE 2
Zinc precipitation assays

| Solutions | | | | | | | |
|---|---|---|---|---|---|---|---|
| (g/L) | Zn | Cu | SiO2 | Ca | NH₃ | SO₄ | Tot S |
| T = 0 | 14.7 | 0.43 | <0.001 | 0.01 | 31.9 | 22.6 | 7.6 |
| (pH 8.8) | | | | | | | |
| PH 8.0 | 5.8 | 0.41 | <0.001 | 0.01 | 13.7 | 22.8 | 7.7 |
| PH 7.5 | 1.7 | 0.38 | <0.001 | 0.01 | 8.8 | 21.9 | 7.3 |
| PH 6.8 | 0.46 | 0.33 | <0.001 | 0.02 | 7.3 | 21.2 | 7.0 |

| Solids | | | | | | | | | |
|---|---|---|---|---|---|---|---|---|---|
| (%) | Zn | Cu | Pb | SiO2 | Ca | NH₃ | SO₄ | Tot S | CO₃ |
| PH 8.0 | 58.5 | 0.31 | 0.25 | 0.73 | 0.24 | | 2.7 | 0.9 | 20.5 |
| PH 7.5 | 58.1 | 0.42 | 0.05 | 0.51 | 0.13 | 0.9 | 4.7 | 1.6 | 19.0 |
| PH 6.8 | 57.6 | 1.3 | 0.08 | 0.19 | 0.11 | 0.8 | 6.2 | 1.9 | 15.0 |

The purity of the zinc product can be improved by stopping the reaction at a higher pH at the expense of zinc recovery as shown below. There will be an economic trade-off between these two factors.

| | | Zinc | | Basic | Basic |
|---|---|---|---|---|---|
| Final | Zinc in | hydroxide- | Zinc | zinc | copper |
| pH | product | carbonate | recovery | sulphate | carbonate |
| 8.0 | 58.5% | 87.8% | 59.4% | | |
| 7.5 | 58.1% | 87.2% | 88.1% | 6.1% | 0.7% |
| 6.8 | 57.6% | 84.8% | 96.8% | 7.4% | 2.3% |

In the instance when the zinc precipitation stage was stopped at a pH of 6.8, the solid assay comprised approximately 85% zinc hydroxide-carbonate (8Zn(OH)₂.3ZnCO₃), 7% basic zinc sulphate and 2.3% basic copper carbonate. Therefore a total of 96.8% of the zinc in the liquid phase fed to the zinc precipitation (stage 2) was precipitated.

In the instance when the zinc precipitation stage was stopped at a pH of 7.5, the solid assay comprised approximately 87% zinc hydroxide-carbonate (8Zn(OH)₂.3ZnCO₃), 6% basic zinc sulphate and 0.7% basic copper carbonate. Therefore, in this instance a total of approximately 88.1% of the zinc in the feed to stage 2 was precipitated.

Copper precipitation commences after zinc, at approximately pH 7.5. Lead and silica appear to precipitate relatively quickly and therefore their solids assays declines subsequently over the course of the experiment.

### EXAMPLE 3

### Sulphate Precipitation

The solution from Example 2 was again heated to about 95° C. and sparged with oxygen for 2 hours. Lime was added as a 500 g/L slurry to maintain the pH at approximately 7.0. Over this time, a precipitate formed and analysis of timed samples collected (Table 3) indicates that the precipitate contained a mixture of calcium carbonate and calcium sulphate. The final liquor contained very low levels of zinc, copper and ammonia.

TABLE 3
Gypsum precipitation assays

| Time (hrs) | Zn | Cu | Ca | NH₃ | SO₄ |
|---|---|---|---|---|---|
| Solutions | | | | | |
| 0 | 0.34 | 0.054 | 0.02 | 7.1 | 19.6 |
| 0.25 | 0.42 | 0.054 | 0.50 | 5.1 | 14.6 |
| 1 | 0.08 | 0.026 | 0.48 | 2.8 | 8.5 |
| 1.5 | 0.08 | 0.018 | 0.45 | 2.3 | 7.2 |
| 3 | 0.01 | 0.003 | 0.48 | 1.0 | 3.4 |
| 3.5 | <0.01 | 0.002 | 0.53 | 0.6 | 1.4 |
| Solids | | | | | |
| 0 | — | — | — | | — |
| 0.25 | 0.1 | 0.01 | 36.2 | | 1.8 |
| 1 | 0.66 | 0.02 | 35.6 | | 5.2 |
| 1.5 | 0.27 | 0.01 | 34.9 | | 8.4 |
| 3 | 0.41 | 0.05 | 33.4 | | 11.1 |
| 3.5 | 0.49 | 0.06 | 31.6 | <0.1 | 18.4 |

The majority of the precipitate contain calcium compounds, 60% calcium carbonate and 26% gypsum (calcium sulphate). Approximately 85% of the sulphate was precipitated, and 92% of the ammonia was volatilised from the solution.

### EXAMPLE 4

### Calcination

Using a muffle furnace, 10 gram samples of the precipitated zinc product were heated between 200° C. and 500° C., at 100° C. intervals, for a minimum of two hours. The results are presented below in Table 4.

TABLE 4
Calcination Results

| | Zn | NH₃ | CO₃ | SO₄ | Cu | Pb | SiO₂ | Cl | F |
|---|---|---|---|---|---|---|---|---|---|
| Sample | | | | | | | | | |
| 1 | | | | | | | | | |
| Un- | 54.4 | 2.0 | | 12.1 | 0.64 | 0.08 | .60 | <0.01 | <0.01 |
| treated | | | | | | | | | |
| 200° C. | 54.9 | 1.2 | 7.19 | 11.7 | 0.73 | 0.1 | 0.77 | <0.01 | <0.01 |
| 300° C. | 66.0 | 0.5 | 1.00 | 12.0 | 0.81 | 0.11 | 0.75 | <0.01 | <0.01 |
| 400° C. | 66.0 | <0.1 | 0.25 | 12.8 | 0.84 | 0.12 | 0.78 | <0.01 | <0.01 |
| 500° C. | 67.8 | <0.1 | 0.15 | 13.3 | 0.82 | 0.14 | 0.67 | <0.01 | <0.01 |
| Sample | | | | | | | | | |
| 2 | | | | | | | | | |
| Un- | 52.2 | 1.5 | | 14.4 | 1.1 | 0.12 | 0.28 | <0.01 | <0.01 |
| treated | | | | | | | | | |
| 200° C. | 55.9 | 1.1 | 3.85 | 15.8 | 1.2 | 0.12 | 0.26 | <0.01 | <0.01 |
| 300° C. | 62.8 | 0.5 | 0.75 | 17.5 | 1.4 | 0.09 | 0.31 | <0.01 | <0.01 |
| 400° C. | 64.5 | <0.1 | 0.35 | 17.9 | 1.4 | 0.04 | 0.27 | <0.01 | <0.01 |
| 500° C. | 65.1 | <0.1 | 0.15 | 18.0 | 1.4 | 0.05 | 0.29 | <0.01 | <0.01 |

At 300° C., the zinc content of the product had increased by 10% to 63-65% zinc. The ammonia concentration had decreased from 2.0% to 0.5% at 300° C., and to less than 0.1% at 400° C.

This is equivalent to 82% (sample 1) and 71% (sample 2) zinc hydroxide, with minimal amounts of zinc carbonate present. There was approximately 18-24% basic zinc sulphate in the product.

Calcining the product at 300° C. increased the zinc concentration by removal of carbonate to less than 1%.

After calcining the product at 400° C., the ammonia in the product was decreased to below its detection limit. This minimises ammonia release upon dissolution of the zinc product. Calcining the product at approximately 400° C. resulted in increased zinc concentration and complete ammonia removal. Therefore, treating the precipitated product results in reducing the amount of final product to be transported and the Occupational Health and Safety issues associated with ammonia release upon dissolving the product in a hydrometallurgical circuit.

It will be appreciated by those skilled in the art of the present invention that modifications may be made to the preferred embodiment of the invention without departing from the spirit and scope of the invention.

1-46. (canceled)

47. A process for upgrading an ore or concentrate that contains metal sulphur minerals and gangue material, the process including the stages of:
a) selectively leaching the ore or concentrate using an ammoniacal solution containing ammonium carbonate that forms soluble metal ammine complexes;
b) separating the solid and liquid phases formed in stage a) with the liquid phase forming a solution including soluble metal ammine complexes and the solid phase including at least in part the gangue material;
c) removing ammonia and carbon dioxide from the liquid phase formed in step b) under conditions that are selected to facilitate the precipitation of valuable metal(s) and minimise the sulphur content in the valuable metal(s) precipitated; and
d) separating the solid and liquid phases formed in stage c) with the solid phase forming a more-concentrated source of valuable metal.

48. The process according to claim 47, wherein stage a) is carried out at a pH ranging from 7 to 10.5.

49. The process according to claim 47, wherein stage a) is carried out at a temperature ranging from 60 to a temperature just below boiling point.

50. The process according to claim 47, wherein the process includes adding to stage a) a metal oxidant that undergoes a reduction reaction to facilitate the dissolution of the metal sulphur compounds.

51. The process according to claim 50, wherein the metal oxidant can be regenerated by oxidation.

52. The process according to claim 50, wherein themetal oxidant is in the form of a cupric cation.

53. The process according to claim 52, wherein the concentration of copper cations supplied to stage a) in the ammoniacal solution is at least 0.15 g/L.

54. The process according to claim 52, whereby when the metal is zinc and the ore contains sphalerite (ZnS), leaching of sphalerite may be represented by the following reaction:
ZnS+8Cu(NH₃)₄CO₃+4H₂O→Zn(NH₃)₄CO₃+4Cu₂(NH₃)₄CO₃+(NH₄)₂SO₄+3(NH₄)₂CO₃+4NH₃.

55. The process according to claim 54, wherein the process includes maintaining the concentration of ammonia in stage a) at a level in accordance with the following formulae:
[NH₃]≧([Zn]+[Cu])×8)+([SO₄]×2)

56. The process according to claim 52, wherein cupric copper is regenerated by oxidation with oxygen according to the following reaction:
2Cu₂(NH₃)₄CO₃+O₂+4NH₃+2(NH₄)₂CO₃→4Cu(NH₃)₄CO₃+2H₂O

57. The process according to claim 47, wherein an oxygen containing gas is supplied to stage a).

58. The process according to claim 47, wherein an oxygen-rich gas is supplied to stage a).

59. The process according to claim 47, wherein stage c) is carried out at a temperature ranging from 90° C. to boiling point so as to evaporate ammonia and thereby facilitate the precipitation of metal compounds.

60. The process according to claim 59, wherein stage c) includes sparging the liquid phase with steam so as to regulate temperature and provide a carrier gas for further ammonia removal.

61. The process according to claim 47, wherein stage c) is carried out to an end pH of 6.8 or more to minimise the precipitation of metal sulphate minerals.

62. The process according to claim 59, whereby when the metal is zinc the precipitation of zinc and the evaporation of ammonia occurring in stage c) can be represented by the following reaction:
11Zn(NH₃)₄CO₃+48H₂O→8Zn(OH)₂.3ZnCO₃.4H₂O↓+8(NH4)₂CO₃+28NH₄OH

63. The process according to claim 47, further including a stage of calcining the solid phase recovered in stage d).

64. The process according to claim 63, wherein the calcination stage is carried out by heating the solid phase formed in stage c) to a temperature ranging from 100° C. to 500° C.

65. The process according to claim 47, wherein the liquid phase recovered from stage d) is treated to precipitate sulphur and compounds containing sulphur from the liquid phase as a salt.

66. The process according to claim 65, wherein a neutralising agent is added to the liquid phase of stage d).

67. The process according to claim 66, wherein the neutralising agent maintains the pH above 7 during the sulphate precipitation stage to minimise the level of ammonia remaining as ammonium hydroxide.

68. The process according to claim 65, wherein ammonia is removed from the liquid phase recovered from stage d) by heating the liquid phase.

69. A plant for upgrading an ore or concentrate that contains metal(s) sulphur minerals and gangue material, the plant including:
a first stage in which an ammoniacal solution containing ammonium carbonate can selectively leach metal(s) and metal compounds from the ore or concentrate to form soluble metal ammine complexes;
a separator for separating the solid and liquid phases formed, in which, the liquid phase includes soluble metal ammine complexes and the solid phase includes at least in part gangue material;
a second stage that is supplied with the liquid phase formed in the separator and from which ammonia and carbon dioxide are removed under conditions that are selected to facilitate the precipitation of valuable metal(s) and minimize the sulphur content in the valuable metal(s) precipitate; and
a further separator for separating the solid and liquid phases formed in the second stage whereby the solid phase forms a more-concentrate source of valuable metal(s).

70. The plant according to claim 69, wherein the pH in the first vessel ranges from 7 to 10.5.

71. The plant according to claim 69, wherein the temperature in the first stage ranges from 60 to a temperature just below boiling temperature.

72. The plant according to claim 69, wherein a metal oxidant is supplied to the first stage which undergoes a reduction reaction to facilitate the dissolution of the metal sulphur compounds.

73. The plant according to claim 72, wherein the metal oxidant can be regenerated by oxidation.

74. The plant according to claim 73, wherein the metal oxidant is in the form of a cupric cation.

75. The plant according to claim 74, wherein the concentration of copper cations supplied to the first stage in the ammoniacal solution is at least 0.15 g/L.

76. The plant according to claim 73, wherein the metal is zinc and the ore contains sphalerite (ZnS), leaching of sphalerite may be represented by the following reaction:
ZnS+8Cu(NH₃)₄CO₃+4H₂O→Zn(NH₃)₄CO₃+4Cu₂(NH₃)₄CO₃+(NH₄)₂SO₄+3(NH₄)₂CO₃+4NH₃.

77. The plant according to claim 76, wherein the concentration of ammonia in the first stage is maintained at a level in accordance with the following formulae:
[NH₃]≧([Zn]+[Cu])×8)+([SO₄]×2)

78. The plant according to claim 74, wherein the metal oxidant is cupric copper, reduced copper is regenerated by oxidation with oxygen according to the following reaction:
2Cu₂ (NH₃)₄CO₃+O₂+4NH₃+2(NH₄)₂CO₃→4Cu(NH₃)₄CO₃+2H₂O

79. The plant according to claim 75, wherein an oxygen containing gas is supplied to the first stage to regenerate the metal oxidant.

80. The plant according to claim 79, wherein the oxygen containing gas is purified oxygen.

81. The plant according to claim 69, wherein the second stage is carried out at a temperature ranging from 90° to boiling point so as to evaporate ammonia and thereby facilitate the precipitation of metal compounds.

82. The plant according to claim 81, wherein steam is sparged through the liquid phase of the second stage to provide heat and a carrier gas for further ammonia removal.

83. The plant according to claims 69, wherein the second stage is carried out to an end pH of 6.8 or more to avoid excessive amounts of metal sulphate forming.

84. The plant according to claim 71, whereby when the metal is zinc the precipitation of zinc and the evaporation of ammonia occurring in stage c) can be represented by a reaction of the form:
11Zn(NH₃)₄CO₃+48H₂O→8Zn(OH)₂.3ZnCO₃.4H₂O↓+8(NH4)₂CO₃+28NH₄OH

85. The plant according to claim 69, further including a stage of calcining the solid phase recovered in the further separator.

86. The plant according to claim 85, wherein the calcination stage is carried out by heating the solid phase formed in stage c) to a temperature of at least 100° C. and preferably, above 300° C.

87. The plant according to claim 69, wherein the liquid phase from the separator stage d) is treated to precipitate sulphur and compounds containing sulphur from the liquid phase as a salt.

88. The plant according to claim 87, wherein the liquid phase from stage d) be treated by adding a neturalising agent to the liquid phase.

89. The plant according to claim 88, wherein the neutralising agent maintains the pH above 7 during the sulphate precipitation stage to minimise the level of ammonia remaining as ammonium hydroxide.

90. The plant according to claim 87, wherein ammonia is removed from the liquid phase in stage d) by heating the liquid phase and sparging with steam.
